(19) United States
(12) Patent Application Publication
(10) Pub. No.: US 2019/0024998 A1
(43) Pub. Date: Jan. 24, 2019

(54) GUN SHOT COUNTER

(71) Applicants: Bryan Hans Chan, Belmont, CA (US); Justin Lee Pereira, Woodland, CA (US)

(72) Inventors: Bryan Hans Chan, Belmont, CA (US); Justin Lee Pereira, Woodland, CA (US)

(21) Appl. No.: 15/657,216

(22) Filed: Jul. 24, 2017

(51) Int. Cl. F41A 19/01; G01P 1/00; G01P 15/09; G01P 15/12

(52) U.S. Cl. CPC F41A 19/01; G01P 15/123; G01P 15/09; G01P 1/06

(57) ABSTRACT

In an embodiment an electronic device comprising of a processing module, storage module comprising an application software program, memory module, display driver module, display module, detection module, power supply module; configured to be capable of detecting and displaying force events.

### CROSS-REFERENCE TO RELATED APPLICATIONS

This applications claims the benefit of provisional patent application Ser. No. 62/367,126, filed 2016 Jul. 27 by the present inventors.

### FIELD OF THE INVENTION

The present invention is related to a device that detects and tabulates gunshots discharged from a firearm.

### BACKGROUND OF THE INVENTION

The following is a tabulation of some prior art that present appears relevant:

US Patents

| Pat. No. | Kind Code | Issue Date | Patentee |
|---|---|---|---|
| 8,720,092 | B1 | 2014 May 13 | Gussalli Beretta |
| 8,418,388 | B1 | 2013 Apr. 16 | Ferrarini |

Firearms do not have a visual method of indicating the quantity of ammunition remaining in the firearm. Users can count the number of shots fired and mentally calculate shots remaining. For firearms with high capacities, mentally tracking remaining rounds can be difficult more so in high stress situations.

Having the ability to visually track the remaining rounds in a firearm can be convenient and tactically advantageous. For example, a user may choose to replace a magazine or dip when the remaining count is low, but non-zero, for the purpose of preparing for the next engagement.

Another example is that a user would know when a firearm is about to become fully discharged, ie empty, and therefore prepare for the situation appropriately.

Another beneficial use case to track number of discharges a firearm has gone through is to allow users to more easily know when to perform routine service and maintenance on the firearm.

Devices that exist in the market that track shots fired from a firearm store information internally without visually conveying the information to the user in real time. Instead, data is transferred from the device to a computer for analysis at a later time. Other devices transmit data wirelessly to an external device, like a computer or a smartphone.

### SUMMARY OF THE INVENTION

An object of the present invention is to conceive and provide a device for a firearm that detects and counts firearm discharges and supplies visual information to the shooter on number of shots fired or shots remaining, and which is practical, easy to use and easy to install on a firearm.

This invention is a device that visually indicates the quantity of ammunition in a firearm comprising of a display, a sensor to detect gunshot discharge, a processing unit, an input method for resetting the device.

This object is achieved by means of an electronic device comprising of:

a processing module;

a storage module comprising an application software program operatively associated with the processing module;

a detection module for detection of shots fired from a firearm operatively associated with the processing module;

a display unit operatively associated with the processing module;

an optional lighting source operatively associated with the display and processing module;

an optional input device such as a button operatively associated with the processing module;

an optional power supply;

wherein the processing module is configured to tabulate the input from the detection module and convey the information on the display unit.

### BRIEF DESCRIPTION OF THE DRAWINGS

FIG. 1 shows a rear perspective view of a conventional firearm

FIG. 2 shows a block diagram of the device

FIG. 3 shows a display design used on the device

FIG. 4 shows a method of attachment of the device

FIG. 5 shows a profile of a single peak measurement for a detection circuit

FIG. 6 shows a profile of a double peak measurement for a detection circuit

### DETAILED DESCRIPTION OF THE DRAWINGS

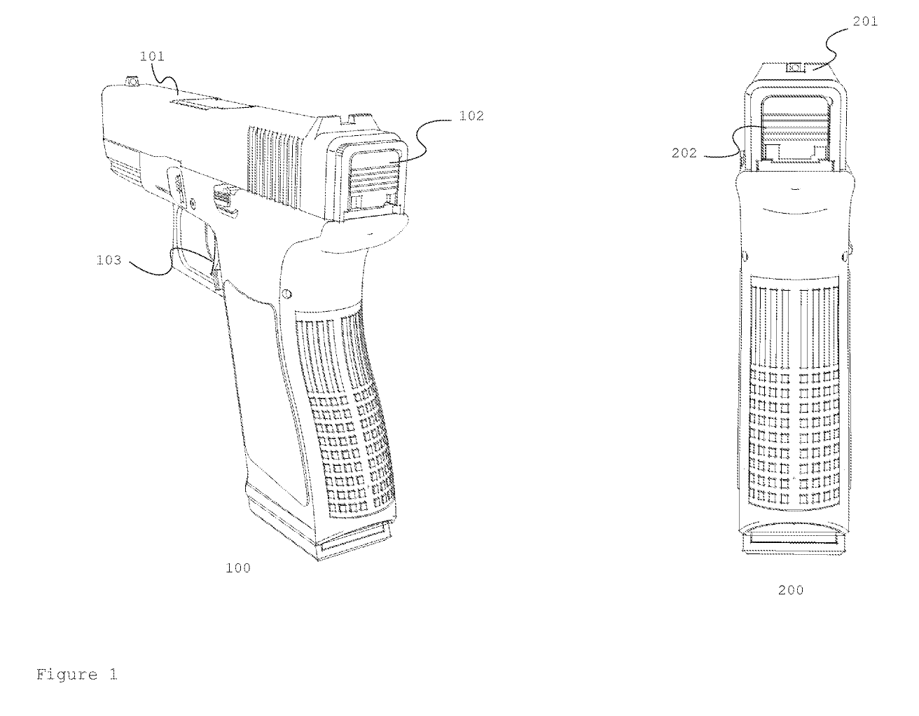

For the purposes of the description herein, a “firearm” is meant, for example, a pistol, a handgun, a carbine, a rifle, a gun, such as that illustrated in FIG. 1.

With reference to the model in FIG. 1, the electronic device can be located on the Slide 101 and 102, more specifically on the rear of the slide where commonly a back plate is located on firearms with striker based firing mechanisms 101 and 102.

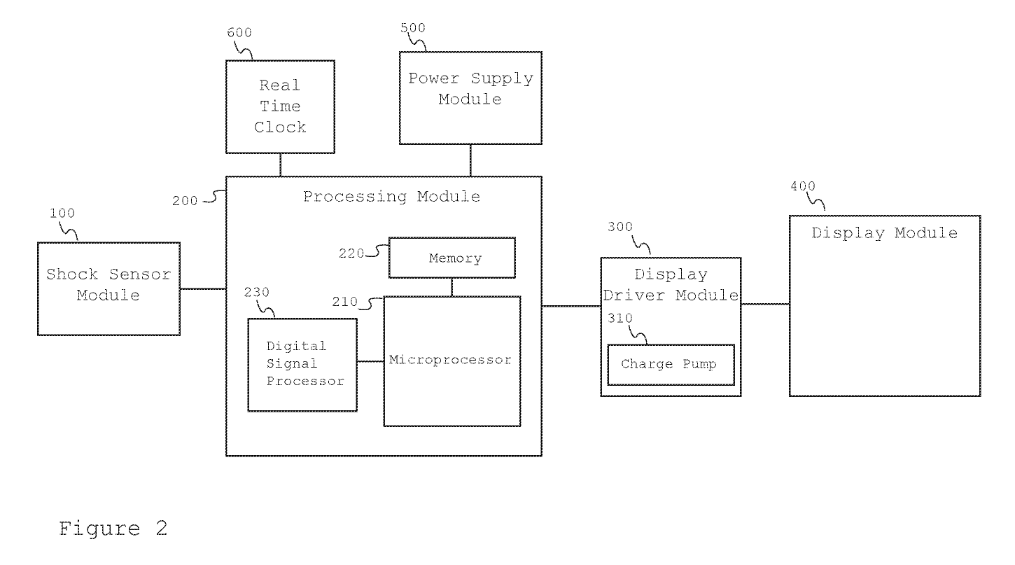

With reference to the block diagram in FIG. 2 the electronic device will now be illustrated and described according to the embodiment of the invention.

The electronic device comprises of a Processing Module 200 responsible for performing calculations and running algorithms on the device.

The Processing Module 200 comprises of a Microprocessor 210, a Memory 220 operationally coupled to the Microprocessor 210, and a Digital Signal Processor 230 operationally coupled to the Microprocessor 210.

The Memory 220 consists of both volatile Random Access Memory and non-volatile memory that stores a processing program loaded and executed by the Microprocessor 210. The non-volatile portion of Memory 210 can comprise of, but not limited to, flash based memory, EEPROM, MRAM, FRAM, or other memories that retain information without the application of power. The processing program, an application software program, and data is stored in the non-volatile portion of Memory 210. The non-volatile portion of Memory 210 can also be used to permanently store heuristic information based on the application software program.

Non-volatile memory is used in order to retain retain information without using energy and results in reduced power consumption when compared to using Random Access Memory.

The electronic device further comprises of a Detection Module 100.

The Detection Module 100 can be a Microelectromechanical Systems (MEMS) device such as an accelerometer or accelerometer and gyroscope. The detection module can also consist of a piezoelectric or piezoresistive device that can produce an output signal proportional to the amount of force experienced by the module. The detection module can also consist of a mass spring device that physically deflects and triggers an output signal based on the acceleration experienced.

The electronic device further comprises of a Display Module 400.

The Display Module 400 can be of, but not limited to, an electrophoretic display, electrochromic display, polymer dispersed liquid crystal display, transflective liquid crystal display, reflective liquid crystal display, electrowetting display, OLED display, active matrix thin film transistor display.

The display device can display numeric information representing remaining rounds in the firearm. The display device can also display numeric information representing a cumulative count of shots fired from the firearm.

The electronic device optionally comprises of a lighting device. The lighting device can be a light emitting diode or a light emitting diode coupled to a light guide structure to distribute light evenly onto the display.

The application software program contains, but not limited to, the following functions: define multiple operating views and in this embodiment three views are used; wherein the first view will display a count-up starting from zero and where the user can reset the count to zero; wherein the second view will display a countdown from a pre-programmed number where the user can reset the count back to the pre-programmed number and where the user can set the pre-programmed number; wherein the third view will display a count-up that cannot be reset by the user and is intended to keep the lifetime count of the device.

The electronic device optionally comprises of a power supply.

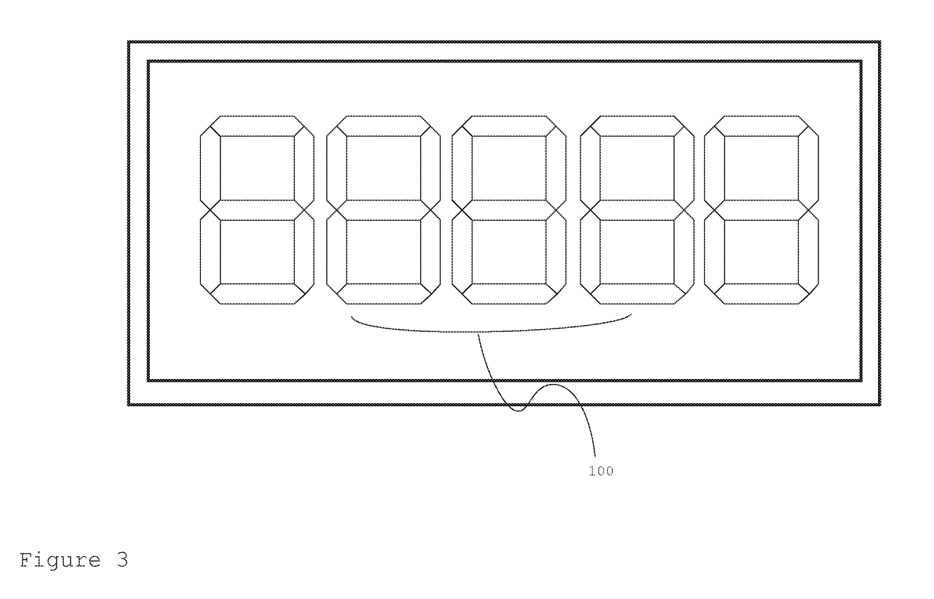

FIG. 3 is an example of what the visual representation of the display used on the device. The display can show less digits depending on the view, shown in 101, such as during the countdown mode.

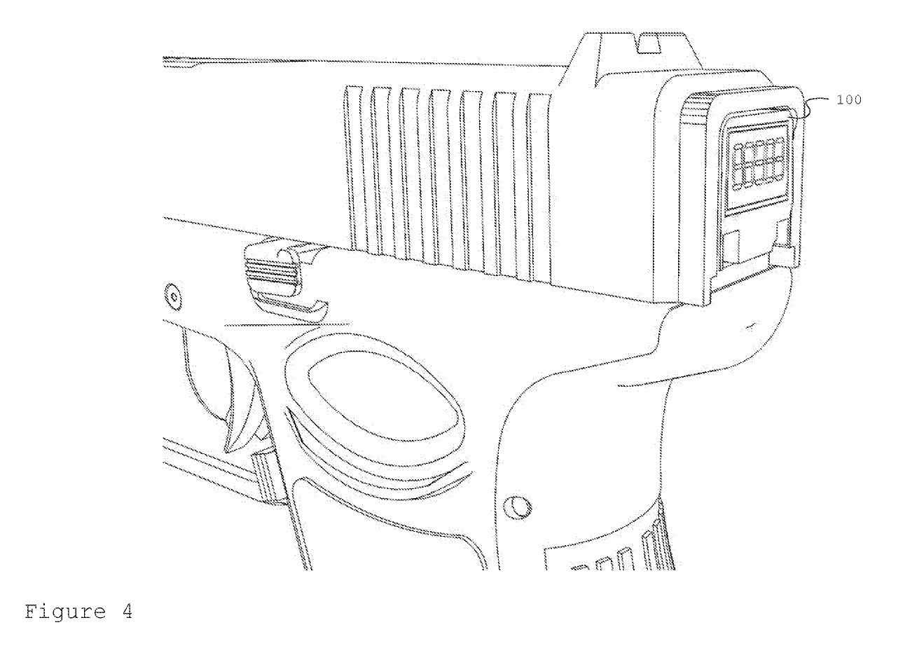

FIG. 4 is a representation of the electronic device attached to the firearm. 100 shows the device attached to the rear of the firearm which can be viewed by the operator of the firearm.

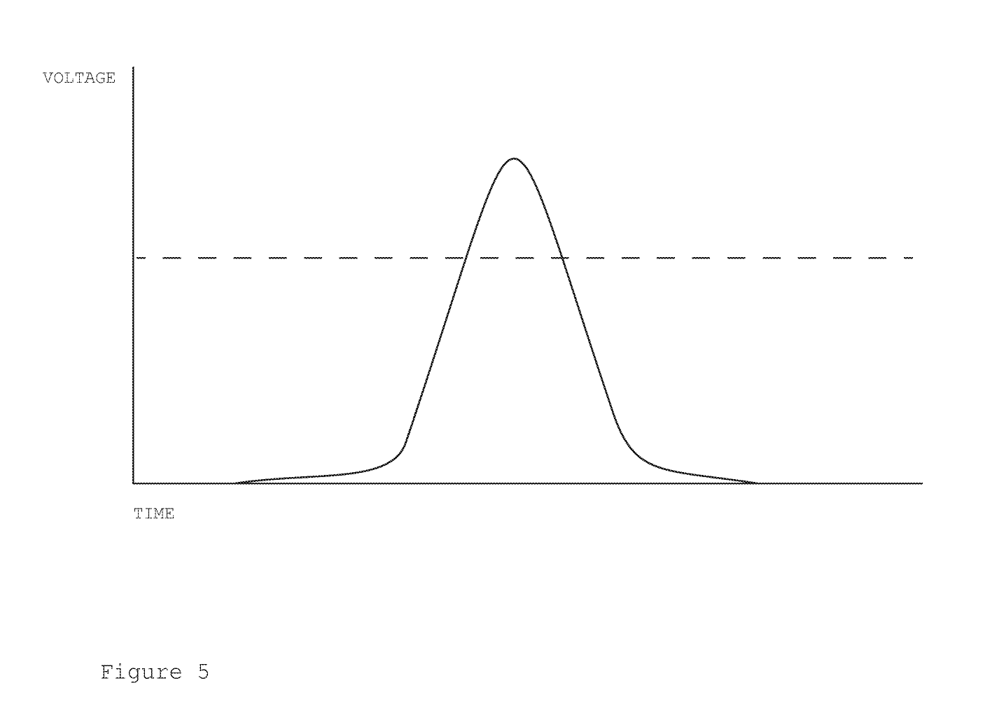

A method of detection of the firearm discharge is shown in FIG. 5. In this method, a sensor outputs an electronic signal that is read by the processing module or the digital signal processor depicted in FIG. 1. The firearm discharge detection is based on the magnitude of the signal.

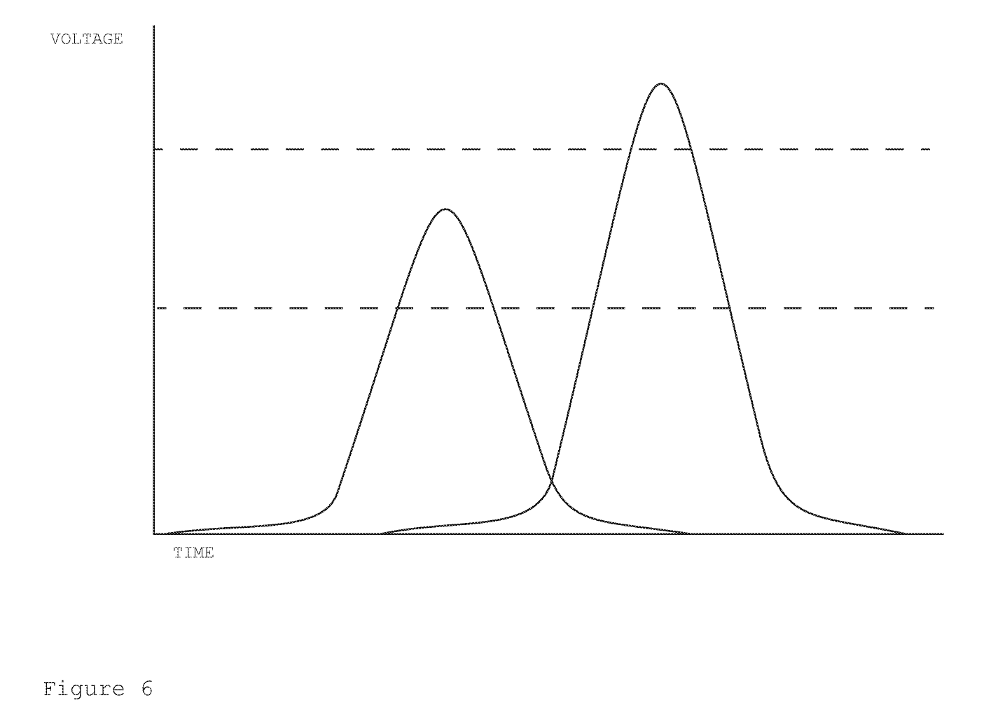

FIG. 6 depicts another method of detection of a firearm discharge using two signals. A firearm discharge commonly comprises of multiple acceleration forces. The first force occurs when the ammunition begins its exit of of the firearm causing the slide of the firearm to move toward the operator in normal firing conditions. The slide of the firearm will continue to move toward the operator until it reaches the end of its travel along the firearm frame. An acceleration force in the opposite direction and of greater magnitude is generated when the slide reaches the end of its travel. Detecting a signal of relative smaller magnitude followed by a signal of relative larger magnitude can be used to detect for firearm discharge. This method may reduce the amount of false positives for the device.

What is claimed is:

1. An electronic device for tabulating shots fired from a firearm comprising of:
a processing module;
a detection module for detecting a shot fired coupled to the processing module;
a display driver electronic circuit module coupled to the processing module;
a display module coupled to the display driver;
a storage module storing an application software program coupled to the processing module;
a memory module coupled to the processing module; and
a power supply unit;
wherein the processing module is configured to detect the output of the detection module and tabulate the number of shots detected and sending the number to the display;
the detection module comprises a force sensor which generates an electric signal when acceleration is experienced by the electronic device.

2. The electronic device in claim 1 wherein the detection module comprises of a piezoelectric sensor.

3. The electronic device in claim 1 wherein the detection module comprises of a piezoresistive sensor.

4. The electronic device in claim 1 wherein the detection module comprises of a microelectromechanical device.

5. The electronic device in claim 1 wherein the display module comprises of an electrophoretic display.

6. The electronic device in claim 1 wherein the display module comprises of an electrochromic display.

7. The electronic device in claim 1 wherein the display module comprises of a liquid crystal display.

8. The electronic device in claim 1 wherein the display module comprises of a light emitting diode display.

9. An electronic device for detecting shots fired from a firearm comprising of:
a processing module;
a detection module for detecting a shot fired coupled to the processing module;
wherein the detection module outputs a continuous electric signal proportional to the acceleration experienced by said detection module;
a storage module storing an application software program coupled to the processing module;
a memory module coupled to the processing module; and
a power supply unit;
wherein the processing unit is configured to detect the electric signal output by the detection module and use the approximate amplitude, frequency, and shape of the electric signal to determine a shot fired from a firearm;

10. The electronic device in claim 9 wherein the processing module is configured to determine shots fired from a firearm based on the amplitude of the electric signal output from the detection module.

11. The electronic device in claim 9 wherein the processing module is configured to determine determine shots fired from a firearm based on the electric signal output from the detection module where said electric signal exhibits a first local maximum and a second local maximum where said first local maximum is less than said second local maximum and said second local maximum occurs less than 100 milliseconds after said first local maximum.

12. The electronic device in claim 9 wherein the detection module comprises of a piezoelectric sensor.

13. The electronic device in claim 9 wherein the detection module comprises of a piezoresistive sensor.

14. The electronic device in claim 9 wherein the detection module comprises of a microelectromechanical device.

15. The electronic device in claim 9 wherein the detection module comprises of a mass spring device.
